(19) United States
(12) Patent Application Publication
(10) Pub. No.: US 2022/0148210 A1
(43) Pub. Date: May 12, 2022

(54) Computer-implemented method for ascertaining a value of a geometric parameter

(71) Applicant: Volume Graphics GmbH, Heidelberg (DE)

(72) Inventors: Sven GONDROM-LINKE, Heidelberg (DE); Gerd SCHWADERER, Heidelberg (DE); Christof REINHART, Heidelberg (DE); Christoph POLIWODA, Heidelberg (DE); Sören SCHÜLLER, Heidelberg (DE); Matthias FLESSNER, Heidelberg (DE); Markus RHEIN, Heidelberg (DE); Thomas GÜNTHER, Heidelberg (DE)

(21) Appl. No.: 17/523,704

(22) Filed: Nov. 10, 2021

(30) Foreign Application Priority Data
Nov. 11, 2020 (DE) 10 2020 129 792.0

(51) Int. Cl. G06T 7/60; G06T 7/70; G06T 7/00; G06T 7/80

(52) U.S. Cl. CPC G06T 7/60; G06T 7/70; G06T 2207/30204; G06T 7/001; G06T 7/80; G06T 7/0006

(57) ABSTRACT

Described is a computer-implemented method for ascertaining a value of a geometric parameter of at least one part to be measured of an object from at least one two-dimensional image of a measurement volume, wherein the measurement volume includes the object and the part of the object that is to be measured has a position in the measurement volume, wherein the at least one two-dimensional image is assigned to a recording geometry, wherein the recording geometry describes a geometric relationship between a detector for ascertaining two-dimensional images and the object, wherein the method comprises: ascertaining at least one two-dimensional image of the measurement volume; and identifying the at least one part to be measured of the object in the at least one two-dimensional image, and ascertaining a value of the geometric parameter of the at least one part to be measured that has been identified.

### RELATED APPLICATION INFORMATION

This patent claims priority from German Patent Application No. 10 2020 129 792.0, filed Nov. 11, 2020, all of which are incorporated herein by reference in their entirety.

The invention relates to a computer-implemented method for ascertaining a value of a geometric parameter.

During or after the manufacture of components, dimensional measurements in two-dimensional images of the components can be carried out for quality assurance. The length of a segment to be measured on the component can, for example, be ascertained for dimensional measurements. The distance of the ends of the segment from one another is determined for this purpose. The determination of the distance between the ends of the segment depends on the distance of the segment ends from the imaging apparatus with which the two-dimensional image of the component was acquired. Depth information relating to the position of the segment ends in the two-dimensional image must therefore be known or ascertained. The distance represented can be converted into a dimensional variable with the depth information.

The use of telecentric objective lenses in profile projectors in optical measurements is known (see, for example, Rainer Schuhmann, Thomas Thöniß: Telezentrische Systeme für die optische Meßund Prüftechnik (Telecentric Systems for Optical Measurement and Test Technology), in: Technisches Messen, Volume 65, No. 4, 1998, ISSN 0171-8096, pp. 131-136 and Dutschke W. (2002) Meßmikroskop and Profilprojektor (Instrumentation Microscope and Profile Projector), in: Fertigungsmesstechnik. Vieweg+Teubner Verlag), in which the imaging scale is constant, independently of the distance of the object from the objective lens. These are, however, comparatively expensive, in addition to which profile projectors can usually only be used for measurements in a clearly defined measurement plane. Objective lenses are thus usually used in which the imaging scale is not independent of the distance of the object from the objective lens. The transmission of x-rays through an object usually also exhibits this property if, for example, a conical beam geometry is formed by the x-ray source and the area detector. Deriving depth information from the two-dimensional image or projection resulting from this is not trivial. The segment to be measured must, moreover, first be identified and localized at the component. This is not trivial when a computer-implemented method is used, in particular if a subpixel accuracy is to be achieved. The time required also increases if, for example, the segment ends have different distances from the imaging apparatus.

The object of the invention, therefore, is to create a method with which measurements can be carried out as quickly and accurately as possible when taking measurements in two-dimensional images of components.

The primary features of the invention are given herein.

According to the invention, a computer-implemented method for ascertaining a value of a geometric parameter of at least one part to be measured of an object from at least one two-dimensional image of a measurement volume is provided, wherein the measurement volume includes the object and the part of the object that is to be measured has a position in the measurement volume, wherein the at least one two-dimensional image is assigned to a recording geometry, wherein the recording geometry describes a geometric relationship between a detector for ascertaining two-dimensional images and the object, wherein the method comprises the following steps: ascertaining at least one two-dimensional image of the measurement volume; and identifying the at least one part to be measured of the object in the at least one two-dimensional image, and ascertaining a value of the geometric parameter of the at least one part to be measured that has been identified.

The invention thus provides a computer-implemented method with which a part to be measured of the object is identified, and is subjected to a dimensional measurement. For this purpose, after ascertaining the two-dimensional image of the measurement volume in which the object is arranged, the part of the object that is to be subjected to a dimensional measurement is first identified. The identified part of the object is then subjected to a dimensional measurement with which a value of a geometric parameter is ascertained. Since the ascertainment of the geometric parameter is preceded by the identification of the part of the object that is to be measured, the geometric parameter can be ascertained with sufficient accuracy. The geometric parameter can, for example, be the position of an edge or other surface with reference to a part of the object, the diameter, the alignment and/or the depth of a hole, the diameter of a bolt, the distance between two parts of the object or of geometric features such as a hole, or the distance between two points of the object. A geometric parameter that can be used for a quality assurance of the object is made available with the invention by means of a two-dimensional image of the object to be measured. The two-dimensional image can, for example, be a radiographic image or an optical image of the object. The radiographic image can, for example, be ascertained by means of radiography using, for example, a conical beam geometry. The optical image can, for example, be ascertained by means of a camera, which may have a defined angle of view. The dimensional measurement can thus ascertain a value of a geometric parameter of at least one part of the object. The quality assurance can thus be carried out with a low number of two-dimensional images, for example with only one two-dimensional image of the object to be measured. The dimensional measurement can be carried out in this way in a short time and with sufficient accuracy.

The recording geometry can, for example, be the relative positioning between the object to be measured and the component of a system for ascertaining two-dimensional images of the object, wherein the components can, for example, be a radiation source and a detector, or an instrumentation camera. The relative positioning between a detector for ascertaining two-dimensional images and the object can, for example, be described in terms of distances from one another. An alignment of the object in relation to the detector can also be described by the recording geometry.

In one example, the step of identifying the at least one part to be measured of the object in the at least one two-dimensional image, and ascertaining a value of the geometric parameter of the at least one part to be measured that has been identified, can further comprise the following sub-steps: providing at least one two-dimensional reference image that includes at least one known value of at least one geometric reference parameter; and comparing the at least one two-dimensional reference image with the at least one two-dimensional image.

The value of the geometric parameter is measured here in that a comparison of the at least one ascertained two-dimensional image with at least one two-dimensional reference image for which the value of the geometric parameter to be ascertained is known is carried out.

According to this example, the at least one two-dimensional reference image can represent a measurement volume that includes a reference object with the same target geometry as the object, wherein the at least one two-dimensional reference image is, in particular, a simulated or real image of the reference object.

The reference image can be a simulated or real two-dimensional image of a reference object with the same nominal geometry as the object to be measured. The recording geometry of the two-dimensional reference image of the reference object should be as identical as possible to the recording geometry with which the two-dimensional image of the measured object was ascertained. In the case of the simulated reference image, a radiographic simulation, or a forward projection, or an optical simulation of the object can be used. For the simulation or the forward projection, a CAD model of the object or of the geometry of another object, which may have been measured with a different sensor, can be used as the basis. The real recording of the reference image is carried out with an object whose geometry, or whose relevant geometric properties, are known. This can, for example, be ascertained by a reference measurement with a different sensor. The values of the measured variables to be measured in the two-dimensional reference image are thus known in both cases.

Furthermore, in this example the step of identifying the at least one part to be measured of the object in the at least one two-dimensional image, and ascertaining a value of the geometric parameter of the at least one part to be measured that has been identified, can further comprise the following sub-steps: ascertaining the position of the at least one identified part to be measured in the represented measurement volume by means of the at least one two-dimensional image; ascertaining a further position in the two-dimensional reference image, wherein the further position is assigned to the at least one geometric reference parameter; and ascertaining a deviation between the ascertained position and the further position; ascertaining a value of the geometric parameter of the at least one part to be measured that has been identified by means of the ascertained deviation.

In this example the position or the positions of the geometric parameter to be measured in the two-dimensional image, and the deviation from the two-dimensional reference image, are ascertained. A value of the geometric parameter is derived from this. It may be the case that initially this value can only be calculated within a projection plane of the object, or its projection on the projection plane. The position of the parts to be measured in the two-dimensional image or images can, for example, be ascertained through conventional pattern recognition, for example through a recognition of edges or transitions from low to high grey values.

According to this example, it is further possible for an image correlation method to be used in the sub-step of comparing the at least one two-dimensional reference image to the at least one two-dimensional image.

Methods of image correlation, digital image correlation (DIC) for example, are used in this example to ascertain deviations in the two-dimensional image from the reference image. A DIC analyses image data in pairs, and ascertains an association between the two images on a local level. It is possible on the basis of this association to ascertain where the parts that are desired or that are to be measured, or the geometric parameters, are located in the measurement data that underlie the two-dimensional image. This occurs implicitly through the comparison with the reference image, so that, for example, no pattern recognition is needed in order to explicitly identify the parts of the object that are to be measured. This pattern recognition would otherwise have to be configured specifically for every task for each individual part of the object that is to be measured, whereas DIC is almost universally applicable. As soon as the association between the two-dimensional reference image and the ascertained two-dimensional image has been ascertained by the DIC, values for geometric parameters for the ascertained two-dimensional image can be ascertained. This can, for example, be done through taking into consideration the reference values and the distortions or differences between the two-dimensional image and the two-dimensional reference image, which can be described by local displacement vectors. Alternatively, the position of the parts to be measured in the two-dimensional image can be ascertained by the DIC, and the value for the geometric parameter can be derived directly from this. This can, for example, be the distance between two opposite edges, which in this case would each be a part to be measured of the object.

In a further example, it is possible in the step of ascertaining at least one two-dimensional image of the measurement volume, at least two two-dimensional images of the measurement volume are ascertained representing the object from different directions, wherein, at least in the step of identifying the at least one part to be measured of the object in the at least one two-dimensional image, and ascertaining a value of the geometric parameter of the at least one part to be measured that has been identified, all of the at least two two-dimensional images are used together.

Two-dimensional images that represent the object from different directions are evaluated for a geometric parameter. The measurement result for the geometric parameter is derived from a consideration of them all. If a geometric parameter, or a part to be measured of the object, is examined in at least two images with appropriately different recording geometry, the position in three dimensions of the measurement volume, and thus the depth information, can be ascertained, for example through triangulation. The value of the geometric parameter can now in this way be derived using the knowledge of the distance of the part of the object that is to be measured from the detector. It is, equally, also possible to ascertain the values of the geometric parameter in three dimensions instead of ascertaining the projection of the geometric parameter onto the image plane of the two-dimensional images. Furthermore, for example, individual preliminary values of the geometric parameter can be ascertained from the two-dimensional images, and these can be used to calculate a final value of the geometric parameter, for example through weighted averaging. The more two-dimensional images taken from different directions are included in the ascertainment of the geometric parameter, the more accurate does the ascertained value tend to be. In this case, a reconstruction of the volume data is not essential, since the ascertainment of the value of the geometric parameter is still always carried out in the two-dimensional images. In this way, fewer two-dimensional images or projections tend to be necessary than would be the case for ascertainment of a value of the geometric parameter by means of a full reconstruction of volume data from the two-dimensional images.

Furthermore, in the step of ascertaining the at least one two-dimensional image of the measurement volume, the at least one part of the object that is to be measured can be represented for example in strips, and/or the geometric parameter can extend parallel to the detector, for example within a predefined tolerance angular range.

The recording geometry is chosen in such a way that the part to be measured of the object is as far as possible represented in strips and/or the value of the geometric parameter that is to be measured is oriented as parallel as possible to the detector during the measurement. For example, a length to be measured can in this way be measured more accurately, since a change in the length resulting from a change in the position of the parts to be measured of the object, in this case the two ends, which are represented as edges in the two-dimensional image, and thereby also changes in the length to be measured, can be better recognized in the two-dimensional image. This would not be the case if the length were oriented perpendicularly to the detector. In that case, it would be difficult not only to measure the position of the part to be measured in the two-dimensional image, but also to identify the part to be measured at all. In a further step it is, alternatively or in addition, possible to ensure that these parts to be measured of the object, or regions in the two-dimensional images, do not mutually overlap with nor are covered by other geometries or edges.

In a further example, it is possible in the step of ascertaining at least one two-dimensional image of the measurement volume, at least two two-dimensional images of the measurement volume representing the object from different directions are ascertained, wherein the method, between that step and the step of ascertaining a value of the geometric parameter of the at least one identified part to be measured comprises the following steps: ascertaining at least one region in the at least two two-dimensional images, in which no part of the object is arranged; and ascertaining at least one envelope surface in the measurement volume that encloses the object, by means of the at least one region; wherein in the step of ascertaining a value of the geometric parameter of the at least one identified part to be measured, the value is ascertained by means of the envelope surface.

An envelope surface of the object is calculated on the basis of a recognition of those regions of multiple two-dimensional images in which no part of the object is disposed. The value of the geometric parameter is measured with the aid of this envelope surface. In a two-dimensional image that has been ascertained by means of a radiographic measurement of the object or of the measurement volume, regions where the radiation is not attenuated indicate regions of the measurement volume in which no part of the object is disposed. These regions can be identified very easily and quickly in a two-dimensional image that has been ascertained by means of a radiographic measurement. An approximate geometry of the object in the measurement volume can be predicted very easily, without having to perform a reconstruction of the volume data, if this information is present from various directions. A value for the geometric parameter can be ascertained on the basis of this approximate geometry of the object. Both the recording of the two-dimensional images and the ascertainment of the geometric parameter are very fast in this case. The envelope surface here is an estimate of the surface of the object in the measurement volume. Apart from measurement errors, the true surface of the object can only lie within or touch the region enclosed by the envelope surface. The envelope surface can be convex. It is possible here to search explicitly for boundary regions in the two-dimensional images that represent the transition between the regions without attenuation and those with, i.e. without and with the object. The position of the boundary regions in the two-dimensional images can also be ascertained with subpixel accuracy. The envelope surface can be ascertained more accurately on the basis of this information.

In combination with the step of ascertaining the at least one two-dimensional image of the measurement volume, wherein the at least one part to be measured of the object is represented as strips, and/or the geometric parameter extends parallel to the detector within a predefined tolerance angular range, it is in this case advantageous if the object is oriented in such a way, or the recording geometry is chosen in such a way, that the parts of the object to be measured and/or the regions in which the geometric parameters to be measured are disposed are irradiated as far as possible in strips. It can further be advantageous to avoid overlapping with other geometries or edges.

In a further example, the step of identifying the at least one part to be measured of the object in the at least one two-dimensional image, and ascertaining a value of the geometric parameter of the at least one part to be measured that has been identified, can further comprise the following sub-step: ascertaining the position of the at least one identified part to be measured in the measurement volume from a pre-known position and alignment of the object in the measurement volume, and a pre-known geometry that is assigned to the object.

In order to ascertain a value of the geometric parameter from a position or difference from a reference image ascertained in a two-dimensional image, use can be made of the position of the geometric parameter or of the part to be measured with respect to the distance from the detector in the ascertained two-dimensional image. This can be derived from prior knowledge regarding the geometry of the object and the pose with respect to the recording geometry. The prior knowledge of the geometry can originate, for example, from a CAD model, a measurement of the same object, for example using the same detector in the context of a preliminary scan, or with another detector or a measurement of an object with the same nominal geometry. A fast reconstruction of multiple previous two-dimensional images can furthermore be carried out, in order to obtain a rough estimate of the geometry of the object.

According to a further example, it is possible in the step of ascertaining at least one two-dimensional image of the measurement volume, that at least two two-dimensional images of the measurement volume are ascertained representing the object with different recording geometries, wherein the step of identifying the at least one part to be measured of the object in the at least one two-dimensional image, and ascertaining a value of the geometric parameter of the at least one part to be measured that has been identified, further comprises the following sub-steps: ascertaining a two-dimensional position of the at least one identified part to be measured of the object in the at least two two-dimensional images; ascertaining the position of the identified at least one part to be measured in the measurement volume by means of the two-dimensional positions of the identified at least one part to be measured in the at least two two-dimensional images, and a change between the different recording geometries.

Two-dimensional images can be ascertained while the recording geometry is changed. The change to the recording geometry can take place by means of changing the relative position and alignment between the object to be measured and the detector. A part to be measured of the object is followed through the ascertained two-dimensional images, wherein at least two two-dimensional images are ascertained. The position in space of the part to be measured of the object can be ascertained from the change in the position of the part to be measured over the different two-dimensional images and the change in the recording geometry. Information about the change in the recording geometry, ascertained, for example from the axes used, can be taken into consideration here.

This relates in particular to the ascertainment of the position of the part to be measured of the object parallel to a radiation direction or direction of observation, which corresponds to the distance from the detector. In the case of a radiographic measurement, this can relate to the position within the conical beam, or, in the case of an optical measurement, to the position within the field of view of the camera which can, for example, have approximately the form of the pyramid. A change in the positioning of the part to be measured can in particular be made perpendicularly to the radiation direction in order to enable an accurate ascertainment of the position of the part to be measured or of the distance from the detector. The object can, for example, be displaced along the distance a in a defined direction, wherein the distance a can be known, if the positioning is carried out with the aid of highly accurate axes.

Before the step of ascertaining at least one two-dimensional image of the measurement volume, the method can, for example, further comprise the following steps: ascertaining an actual recording geometry of the at least one two-dimensional image; ascertaining a target recording geometry for the at least one two-dimensional image; ascertaining a deviation between the actual recording geometry and the target recording geometry; and correcting the deviation in the actual recording geometry.

To ensure that the recording geometry is correct, the actual recording geometry and the deviations from the target recording geometry are ascertained. This deviation can be corrected with the aid of the axes of the system for ascertaining two-dimensional images of the object. A two-dimensional image can, for example, be recorded for this purpose, and can be compared with a two-dimensional target image, obtained for example from previous measurements or from a simulation. The deviation from the target recording geometry can be determined on the basis of a comparison of the images. Alternatively or in addition, further detectors or sensors can also be used for this purpose.

According to a further example, at least one marker element can be arranged at a predefined position in the measurement volume, wherein the recording geometry of the at least one two-dimensional image is ascertained by means of the at least one marker element.

Marker elements can thereby be attached in the measurement volume. The recording geometry for a two-dimensional image can be accurately ascertained in this way. The knowledge of the recording geometry can be used to check the recording geometry or to ascertain the deviation from the target recording geometry if a target recording geometry is used. If multiple two-dimensional images, or the measurements derived from these images, are considered together, the precise knowledge of the recording geometries can increase the accuracy of the evaluation. The marker elements can be recognized and localized in the two-dimensional image itself. If enough marker elements are recognized in a two-dimensional image, degrees of freedom of the recording geometry, whose number can, for example, be nine, can be ascertained. The mathematical procedures for this are known from, for example, photogrammetry. The marker elements can be further localized, for example with further sensors, in order to calculate the recording geometry. The marker elements can be encoded measurement markers. In the case of a radiographic measurement, the marker elements can be spheres, or small spheres, that are fastened to the object to be measured, to the fixture of the object to be measured, or to other locations of the measurement volume. The various spheres can be arranged in the form of a helix. Covering the parts of the object that are to be measured by the marker elements is avoided if possible.

Before the step of ascertaining at least one two-dimensional image of the measurement volume, the method can, for example, further comprise the following steps: deriving an optimum recording geometry for the at least one two-dimensional image from pre-known properties of the variable to be measured and a geometry of the object.

Optimum recording geometries can, in this example, be derived by means of the knowledge of the geometric parameters to be measured and of the geometry of the object. The dimensional variables can be measured with the highest possible accuracy in these recording geometries. The knowledge of the geometric parameters to be measured can, for example, originate from a CAD model of the object. These optimum recording geometries can then be used in the ascertainment of the two-dimensional images of the object. This can preferably be performed during the ascertainment on the basis of previously imaged parts of the object or of previously ascertained two-dimensional images. The regions or the geometric parameters in which, for example, no reliable values could be ascertained after evaluation of the already present measurement data, can in particular be taken into consideration. A strip-wise observation of the parts of the object to be measured can further be taken into consideration. The recording geometry can further be selected so that these regions do not mutually overlap with other geometries or edges in the two-dimensional images. The geometric parameter to be measured can be oriented as parallel as possible to the detector when ascertaining the two-dimensional images. The largest possible number of marker elements can further be arranged in the individual two-dimensional images. Preferably, the largest possible number of parts to be measured of the object are measured simultaneously, or all the geometric parameters measured in the smallest possible number of two-dimensional images.

According to a further example, it is possible in the step of ascertaining at least one two-dimensional image of the measurement volume, that the at least one two-dimensional image is ascertained by means of a radiographic measurement, and a further object touches the at least one part to be measured of the object, wherein, after the step of identifying the at least one part to be measured of the object in the at least one two-dimensional image, and ascertaining a value of the geometric parameter of the at least one identified part to be measured, a position of the further object is ascertained for determination of the position of the at least one identified part to be measured.

At least one part to be measured of the object can here be touched by a further object. The further object thus touches the surface of the part to be measured of the object. The position of the further object can be measured in the two-dimensional image, present as a radiographic image, and the position of the part to be measured of the object that has been touched can be deduced in this way. This is therefore an indirect measurement. Alternatively or in addition, conventional tactile sensors can be used as further objects. These can themselves register when they touch the surface of an object, for example from a small deflection or a small force that acts on a feeler.

A sphere, such as a sampling sphere known from tactile measurements, can be used in a further example as the object. These can, advantageously, feature a comparatively high x-ray absorption, so that they are as easily recognized as possible in a two-dimensional image ascertained as a radiographic image. In this example, further, the object is irradiated from multiple directions in order to be able to ascertain the position in three dimensions.

It is possible, for example, for a movement of the feeler to be tracked in a sequence of two-dimensional images present as radiographic images in order to recognize the contact. It is possible here to register when this movement changes. If the feeler has previously moved to the object and then remains stationary, a contact has occurred. Similarly, the feeler can also remain stationary while the object is moved. If the feeler then moves, a contact has occurred. The contact direction can be calculated back from this change in the movement. In this way, with predefined information about the centre point and the radius of the feeler sphere, the precise contact point, and thus the position of the surface of the object, can be ascertained.

Instead of single positions, it is also for example possible for multiple positions to be contacted at the same time, for example through a comb-like structure of the sensing elements. Measuring lines can also be acquired if the object, or the sensing elements designed as feelers, is accordingly continuously moved. Multiple measuring lines can also be acquired simultaneously through an offset arrangement of the feelers. The feelers can, for example, be spring-mounted. The spring-mounting can, for example, be designed using spiral springs. Alternatively or in addition, feelers can be used that contact and deflect laterally and that are, for example, mounted by means of leaf springs.

In the case of two-dimensional images that are ascertained as radiographic images, it is possible in a further example, in particular if the object does not have high absorption, i.e. only brings about a low contrast in the two-dimensional images, for flat regions of the object to be coated with highly absorptive material, for example with a lacquer. The geometry of this material can then be measured in the two-dimensional images. The geometry of the object can be concluded from this. The highly absorptive applied material can, in this example, act as a sensing element.

The orientation of the object in the measurement volume can be concluded from the results of this indirect measurement with the sensing elements, combined in relevant cases with information about the geometry of the object, for example from the CAD model. This information about the orientation can be used in other steps of the method in order, for example, to determine the recording geometry or to ascertain the distance of the object from the detector.

The sensing elements used for the indirect measurement can, for example, also be used as marker elements in order to perform a geometric calibration, i.e. an ascertainment of the nine degrees of freedom of the recording geometry.

In a further example, geometric parameters such as the alignment and depth of the part to be measured of the object, for example a hole, can be ascertained with the aid of tools such as tooling balls instead of individual sampling points.

The invention further relates to a computer program product with instructions that are executable on a computer which, when executed on a computer, cause the computer to carry out the method according to the preceding description.

Advantages and effects as well as further developments of the computer program product emerge from the advantages and effects as well as the further developments of the method described above. Reference is therefore made in this respect to the description above. A computer program product can, for example, refer to a data carrier on which a computer program element is stored that contains instructions that are executable for a computer. Alternatively or in addition a computer program product can, for example, also refer to a permanent or volatile data memory such as a flash memory or a working memory that contains the computer program element. Other types of data memory that contain the computer program element are not, however, thereby excluded.

Further features, details and advantages of the invention emerge from the following description of exemplary examples with reference to the drawings, in which:

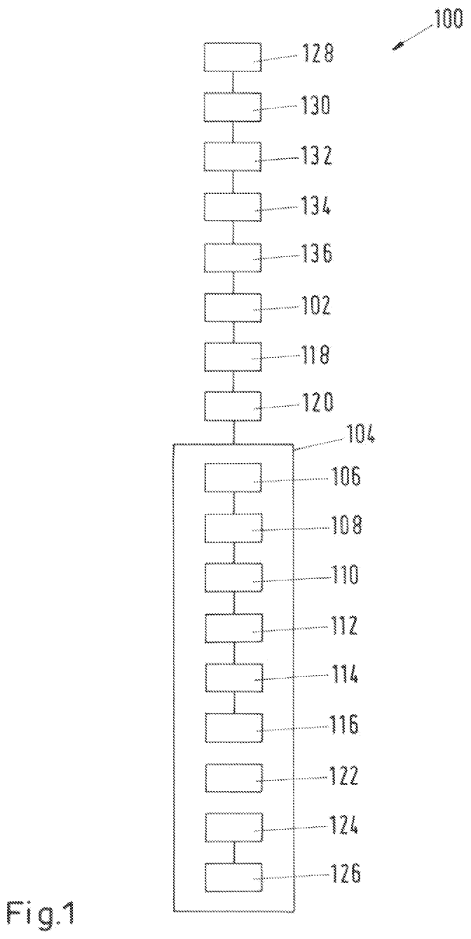

FIG. 1 shows a flow diagram of the computer-implemented method;

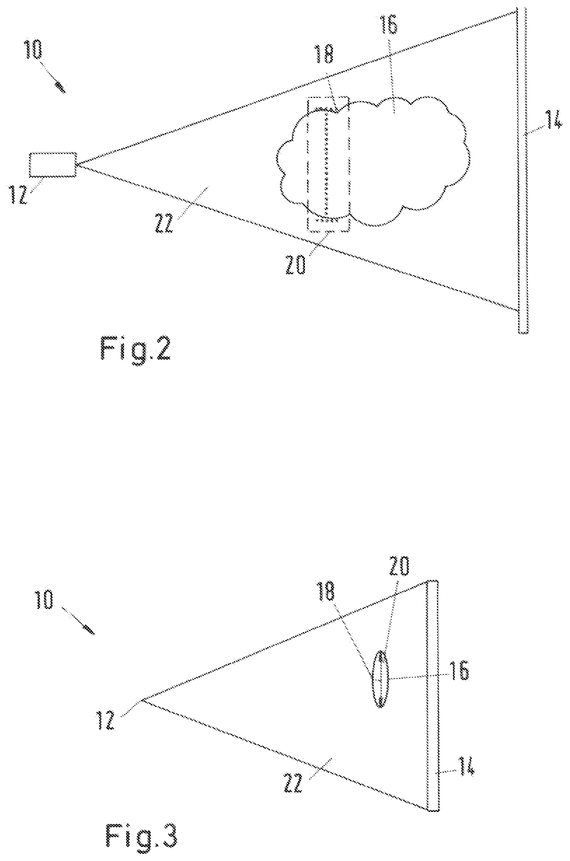

FIG. 2 shows a schematic illustration of the recording geometry of the system;

FIG. 3 shows a schematic illustration of the alignment of the object;

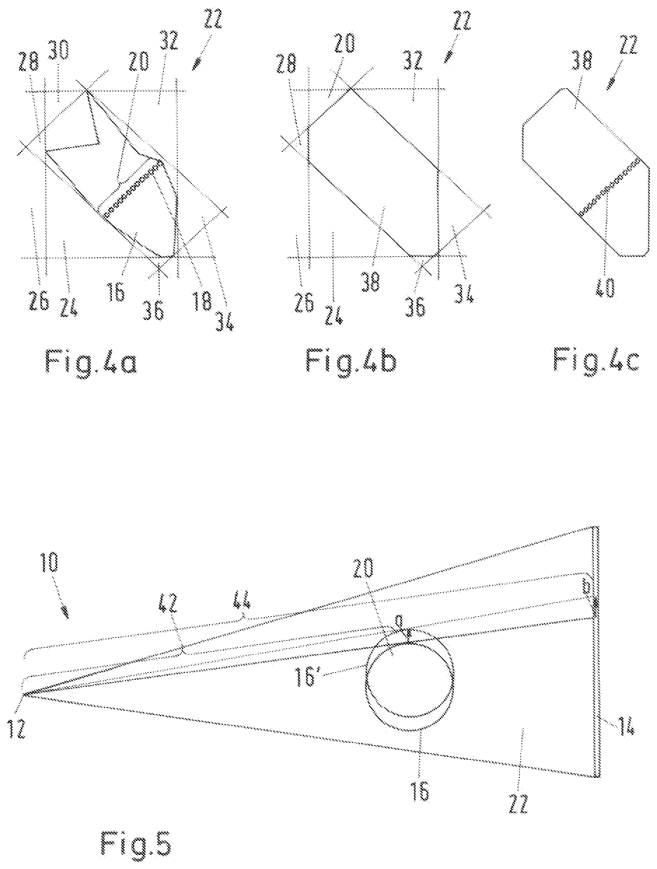

FIGS. 4a-c show a schematic illustration of the measurement volume;

FIG. 5 shows a schematic illustration of a change to the recording geometry; and

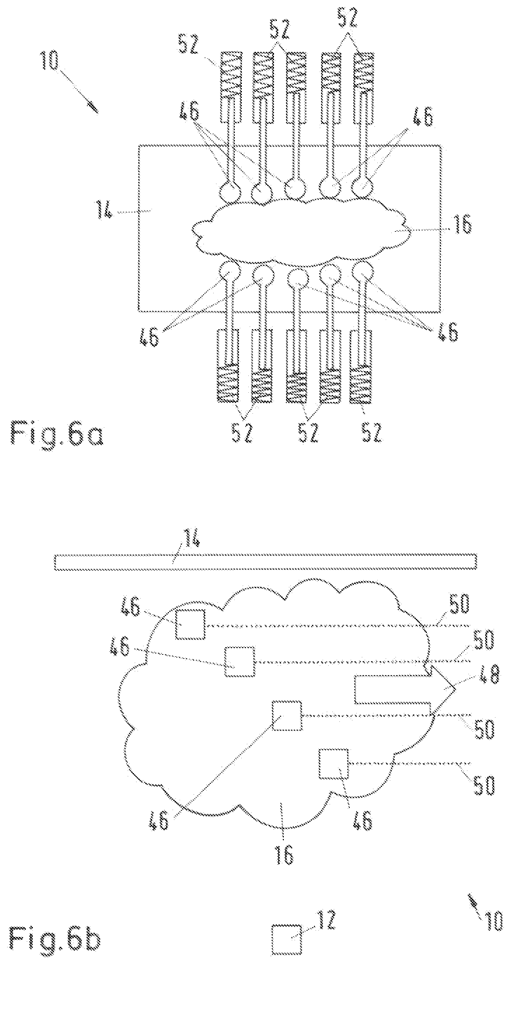

FIGS. 6a, b show a schematic illustration of a system with sensing elements.

The computer-implemented method for ascertaining a value of a geometric parameter of at least one part to be measured of an object from at least one two-dimensional image of a measurement volume is represented in its totality below as in FIG. 1, identified by the reference sign 100.

The method 100 can be used with a system 10 to ascertain a two-dimensional image. As illustrated in FIG. 2, the system 10 includes the measurement volume 22 with the object 16. The measurement volume 22 can be measured by means of the system 10. The system 10 here comprises an element 12 which can be a source of radiation in the case of a radiographic measurement. In the case of an optical measurement, the element 12 can be a camera, wherein the image sensor of the camera can be interpreted as a detector. The system 10 can, furthermore, comprise a further element 14 which in the case of a radiographic measurement, can be a detector and in the case of an optical measurement can, for example, be a screen that forms a high-contrast background for the object 16. The measurement volume 22 with the object 16 can be arranged between the elements 12 and 14.

The object 16 comprises a part 20 to be measured which is surrounded in FIG. 2 by a dashed rectangle. The part 20 to be measured of the object has a geometric parameter, whose value is to be ascertained with the method 100. The part 20 to be measured is furthermore arranged at a position in the measurement volume 22. Various sections of the part 20 to be measured can be arranged at different positions in the measurement volume 22. The object 16 can comprise a plurality of parts 20 to be measured. There can, moreover, be a plurality of geometric parameters to measure, and these can differ. A geometric parameter can, for example, be the position of an edge or of a surface with reference to a part of the object, the diameter, the alignment and/or the depth of a hole, the diameter of a bolt, the distance between two parts of the object or of geometric features of a hole or the distance between two points of the object.

At least one two-dimensional image of the measurement volume is ascertained for this purpose in step 102. The two-dimensional image is a projection image of the measurement volume. Since the measurement volume includes the object, the at least one two-dimensional image of the measurement volume also includes a two-dimensional image of the object.

In the case of a radiographic measurement, the at least one two-dimensional image further comprises a projection image of the part to be measured of the object.

In the case of an optical measurement, the at least one two-dimensional image includes the part to be measured of the object if this faces toward the camera and is not covered by other parts of the object.

In a first alternative, a single two-dimensional image of the measurement volume is ascertained in step 102. In another alternative, two or more two-dimensional images of the measurement volume are ascertained. The different two-dimensional images of the measurement volume can represent the object from different directions.

If at least two two-dimensional images of the measurement volume that represent the object from different directions are ascertained in step 102, all of the at least two two-dimensional images can be used together in the following steps. An average of the results from the at least two two-dimensional images can, for example, be used, or, in a further example, the information regarding the recording geometry can be used in order to perform a triangulation. A change between the at least two two-dimensional images can furthermore also be used in the following steps.

At least one part to be measured of the object can furthermore be imaged in strips in step 102. This can, for example, be done in that the part to be measured of the object is arranged at an edge of the object in the at least one two-dimensional image. In this way, a thickness, for example, of a part to be measured of the object can be ascertained as a geometric parameter with high accuracy and little effort.

Alternatively or in addition, the geometric parameter whose value is to be ascertained can be arranged with an orientation as parallel as possible to the detector. A hole or an opening can thus, for example, be oriented in such a way that its diameter is arranged parallel to the detector.

This is illustrated schematically by FIG. 3. The geometric parameter 18 here extends parallel to the element 14 which, in this example, can be a detector.

The parallelism can be specified within a tolerance range that is defined by an angular tolerance range. The angular tolerance range can be predefined and can, for example, be +5° and −5° with respect to a plane that is parallel to the detector. This too increases the accuracy of the ascertainment of the diameter as a geometric parameter, and reduces the effort for ascertaining the value of the geometric parameter.

Following the step 102, the at least one part to be measured of the object is identified in the at least one two-dimensional image, and a value of the geometric parameter of the identified at least one part to be measured is ascertained in a step 104. In a first example, the identification can be carried out by means of a pattern recognition. In a further example, the identification of the part to be measured is carried out implicitly through further methods. They are described in an exemplary manner below.

Thus, in an optional sub-step 106 of the step 104, at least one two-dimensional reference image is provided. This reference image includes a known value of at least one geometric reference parameter. The at least one geometric reference parameter can be a parameter that is comparable with or equivalent to the geometric parameter of the part to be measured.

Optionally, here, the at least one two-dimensional reference image can represent a measurement volume that includes a reference object with the same target geometry as the object. Since the reference object has the same target geometry as the object, this reference object also includes a reference part that corresponds to the part to be measured of the object. A geometric parameter of the reference part can thus function as a geometric reference parameter for the geometric parameter of the part to be measured.

The two-dimensional reference image can here, in particular, be a simulated or real image of the reference object. A simulated reference image can, for example, be based on a CAD model of the object.

In a further optional sub-step 108 of the step 104 that follows the sub-step 106, a comparison can be carried out between the at least one two-dimensional reference image and the at least one two-dimensional image. The geometric reference parameter, whose value is known, can be compared here with the geometric parameter of the part to be measured. The part to be measured of the object can be identified in this way and a value of the geometric parameter of the part to be measured ascertained at the same time. This simplifies step 104.

The optional sub-step 108 can furthermore be carried out by means of an image correlation method. An implicit comparison that can be carried out easily between the two-dimensional reference image and the two-dimensional image can take place using the image correlation method. A separate pattern recognition to identify the part to be measured of the component is then no longer necessary.

The step 104 can further comprise the optional sub-steps 110, 112, 114 and 116.

The optional sub-step 110 relates to the ascertainment of the position of the identified at least one part be measured in the imaged measurement volume. This is carried out by means of the at least one two-dimensional image.

In the optional sub-step 112 a further position is ascertained in the two-dimensional reference image and is assigned to a reference part of the reference object that has the at least one geometric reference parameter.

The optional sub-steps 110 and 112 can be carried out in any sequence or even simultaneously.

Following this, a deviation between the ascertained position of the identified at least one part to be measured from the further position of the reference part is ascertained in the optional sub-step 114. The deviation can result from different alignments of the object and of the reference object to the system for ascertaining the two-dimensional image. The deviation can alternatively result from tolerances in the manufacture of the object in comparison with the reference object.

In the optional sub-step 116, a value of the geometric parameter of the identified at least one part to be measured is ascertained by means of the ascertained deviation and of the known value of the geometric reference parameter. The position of the part to be measured in the two-dimensional image can thus be ascertained with sufficient accuracy, since the part to be measured must have a similar value for the geometric parameter as the geometric reference parameter. The step 104 is thereby further simplified.

If at least two two-dimensional images of the measurement volume that represent the object from different directions are ascertained in step 102, the optional steps 118 and 120 can be provided between step 102 and step 104.

In the optional step 118, at least one region in which no part of the object is arranged is ascertained in the at least two two-dimensional images. This is explained more closely on the basis of FIGS. 4a to 4c.

The measurement volume 22 is represented in FIG. 4a with the object 16 that includes the part 20 to be measured. The part 20 to be measured has a geometric parameter 18 whose value is to be ascertained. The measurement volume 22 is divided into various regions 24, 26, 28, 30, 32, 34 and 36. The regions 24 to 36 can be ascertained by means of a plurality of two-dimensional images of the measurement volume 32. The regions 24, 26 and 32 are, for example, ascertained from a first two-dimensional image. The regions 28 and 34 can be ascertained from a second two-dimensional image that represents the measurement volume 22, and thereby the object 16, from a different direction, and so forth. These regions 24 to 36 are free from the object, and thereby do not include any part of the object.

A region 38 that includes the object can thereby be ascertained in accordance with FIG. 4b. This region 38 is used in the optional step 120 in order to ascertain an envelope surface in the measurement volume that encloses the object. The envelope surface here surrounds the object. The object, or its surface, at most touches the envelope surface, and otherwise extends within the region enclosed by the envelope surface. The envelope surface can be convex.

In step 104 a value 40 for the geometric parameter 18 is then ascertained by means of the envelope surface, as illustrated in FIG. 4c. The value 40, however, only provides an upper limit for the geometric parameter 18, since the part 20 to be measured lies inside the envelope surface, and does not have to touch the envelope surface.

Step 104 can further comprise the optional sub-step 122.

In the optional sub-step 122, the position of the identified at least one part to be measured within the measurement volume is ascertained, in that reference is made to a pre-known position and alignment of the object within the measurement volume, and a pre-known geometry that is assigned to the object. Prior knowledge of the geometry of the object is thus used. This prior knowledge can, for example, originate from a CAD model of the object, a previous measurement of the object, or a measurement of another object that has the same target geometry as the object to be measured. The prior knowledge can furthermore be achieved in that, for example, in the case of a radiographic measurement, a plurality of two-dimensional images of the object or of the measurement volume are ascertained, and a fast reconstruction that makes the volume data of the object available is carried out with these two-dimensional images. The distance of the object and its parts from the detector can be estimated with the prior knowledge that has been obtained. The position of the part to be measured of the object can be determined with greater accuracy with the estimate of the distance.

The step 104 can furthermore comprise the optional sub-steps 124 and 126 if at least two two-dimensional images of the measurement volume that represent the object with different recording geometries are ascertained in step 102.

A two-dimensional position of the part to be measured of the object in the at least two two-dimensional images is ascertained with the optional sub-step 124. The coordinates of the two-dimensional images can be used here. This means that depth information regarding the position of the part to be measured of the object is initially not yet present.

The ascertained two-dimensional positions intersect in the at least two two-dimensional images of the measurement volume due to the different recording geometries. The change between the different recording geometries is known here.

In optional sub-step 126 the position of the identified at least one part to be measured in the measurement volume can be ascertained with the change between the different recording geometries and the ascertained two-dimensional positions.

This is explained more closely with reference to FIG. 5, which schematically illustrates a change in the recording geometry. The distance a here describes a relative displacement of the object 16 with respect to the element 14 which, in this example, can be a detector. The element 12 can, in this example, be a radiation source. The displaced object has the reference sign 16′. The system 10 can have highly accurate axes (not illustrated) with which the recording geometry can be changed with great precision.

The distance a can be known through the use of highly accurate axes in the system 10 for ascertaining two-dimensional images of the object 16. A change in the position of the part 20 to be measured, for example the upper edge of the object 16, in the two-dimensional image at the element 14 can, for example, be a distance b. The value of the distance b can be measured in the two-dimensional image, for example in pixels. Since the size of the element 14 is known, b can be calculated in millimetres from that. The distance 42 can be the distance of the part 20 to be measured from the element 12, and the distance 44 the distance of the corresponding point of the element 14 from the element 12. If the distance 44 is known, for example calculated from the positioning of the element 14 and the element 12 with the aid of highly accurate axes, the distance 42 that is being sought, the position of the part 20 to be measured in the recording geometry can be calculated using distance 42=distance 44*a/b. With the aid of the knowledge of the distance 42, the ascertainment of the positioning of the measurement object and of the parts to be measured of the object in the measurement volume can be simplified.

This can be applied analogously to an optical measurement with a camera, in which the element 12 can be a camera and the element 14 a screen. In this case, the image would be measured at the element 12. The explanation given above would be accordingly adapted, wherein it would be necessary to note that a camera does not use a point-like image, but also a surface for acquiring the image that is to be recorded. Strictly speaking therefore, in FIG. 5 the optical sensor of the camera would be shifted slightly to the left from the tip of the illustrated triangle, while a lens system can be located at the said tip.

In addition to ascertaining a two-dimensional image before the start and end of the movement of the object 16, it is also possible for two-dimensional images to be recorded during the movement, so that the parts 20 to be measured can be better tracked. It can be helpful here to briefly interrupt the change in the positioning that can be carried out by means of a method of the axes or robot arms, in order to be able to record a two-dimensional image without having to accept motion blur.

The method 100 can optionally comprise the steps 128, 130, 132 and 134 before the step 102.

The recording geometry that is used for the at least one two-dimensional image is ascertained in the optional step 128. This is then referred to as the actual recording geometry.

A target recording geometry for the at least one two-dimensional image is further ascertained in the optional step 130. The target recording geometry can, for example, be ascertained from a previously recorded two-dimensional image of the object. Alternatively or in addition, the target recording geometry can be ascertained from a simulation of the object.

A deviation between the actual recording geometry and the target recording geometry is further ascertained in the optional step 132. Since the actual recording geometry is, as a rule, not identical to the target recording geometry, a deviation is frequently observable. The more accurately the axes of the system 10 can be adjusted, the smaller will the deviation of the actual recording geometry usually be.

The deviation between the actual recording geometry and the target recording geometry is corrected with the optional step 134. The deviation can, for example, be corrected by means of the axes of the system 10.

Further sensors can be utilized for the ascertainment of the actual recording geometry and the target recording geometry.

In a further example, at least one sensing element 46 can optionally be arranged in the system 10, as is illustrated in FIG. 6a, b. The sensing element 46 is arranged at a predefined position in the measurement volume. The recording geometry of the at least one two-dimensional image can be ascertained by means of the sensing element 46.

If at least one two-dimensional image is ascertained by means of a radiographic measurement in step 102, and a further object touches the at least one part to be measured of the object, the position of the further object can be ascertained in step 104 to determine the position of the identified at least one part to be measured. The sensing elements can be used for this purpose.

An indirect measurement of the position of the part to be measured of the object can be carried out in this way.

The sensing elements 46 should be designed here to detect a contact with the surface of the object 16. The object 16 is arranged in the recording geometry in such a way that as far as possible it contacts all the sensing elements 46. The position of the surface of the object 16 at the sensing elements 46 can be ascertained in this way.

FIG. 6a here shows sensing elements 46 that are spring mounted by means of spiral springs 52. They can therefore change their position in the direction of extension of the spiral springs 52. The sensing elements 46 are further designed here such that they bring about a high contrast in a two-dimensional image.

FIG. 6b shows sensing elements 46 that are mounted by means of leaf springs 50. These sensing elements 46 can be deflected sideways towards the leaf springs 50. A movement of the object 16 can further be carried out in order to bring about a change in the recording geometry. The movement is illustrated schematically in FIG. 6b by the arrow 48. Measuring lines that sense the surface of the object 16 can be acquired in this way.

FIG. 6b also shows that the sensing elements 46 are arranged with an offset with respect to one another. Multiple measuring lines can be acquired in this way that can survey multiple lines on the surface of the object without the sensing elements covering each other.

Alternatively or in addition to the sensing elements 46, marker elements can be used having fixed, known positions in the measurement volume. The recording geometry can be ascertained with the known positions of the marker elements, and deviations from the target recording geometry can be ascertained. The sensing elements 46 in FIG. 6b can, for example, be replaced by marker elements, wherein the leaf springs 50 are replaced by rigid holding elements so that the marker elements are arranged with fixed positions in the measurement volume.

Further optional steps can be provided before step 102. The method 100 can thus further comprise the optional step 136.

The optimum recording geometry for the at least one two-dimensional image can be derived from pre-known properties in the optional step 136. The pre-known properties here relate to the value to be measured that is based on the geometric parameter that is to be surveyed. The pre-known properties further relate to the geometry and the material of the object.

The knowledge about the pre-known properties can again originate in this step from a CAD model of the object.

After ascertaining the optimum recording geometry, this optimum recording geometry can be used for the ascertainment of the at least one two-dimensional image. This recording geometry can thus be adjusted optimally to the parts to be measured of the object or to the geometric parameters that are to be ascertained.

If an evaluation in two dimensions for specific parts to be measured is, for example, not possible, or is only possible with insufficient accuracy, then an evaluation in three dimensions can, for example, be carried out locally. This can, for example, take place on the basis of volume data reconstructed from the two-dimensional images. The respective recording geometry must be known for this purpose.

A minimum and maximum geometry of the object that are still permitted can, for example, be used as a basis in the comparison with a two-dimensional reference image. There are thus at least two two-dimensional reference images. If the measured two-dimensional image lies, in terms of the parts to be measured of the object, within these two limits, the measured part of the object is assessed as being OK. In this case it is thus possible that there is no explicit measurement result, for example in millimetres, but only the indication of “OK” or “NOK” as the result of the measurement.

It is further, for example, possible to perform a fast overview scan, possibly also using other sensors, for example optically, in order to ascertain the orientation of the object. In this case, the regions of the parts to be measured of the object can be identified, and the object aligned in accordance with the overview scan.

If, in the example of a radiographic measurement, for example different two-dimensional images are recorded for a recording geometry using different x-ray spectra (dual energy or multi-energy), these can be included in the calculation. Different materials can be better separated or recognized in the two-dimensional images created in this way. The accuracy of a measurement of multi-material objects can be increased in this way.

The invention further relates to a computer program product (not illustrated) that comprises instructions that can be executed on a computer. If these instructions are executed on a computer, they cause the computer to carry out the method 100 that was described above.

The computer program product can, for example, be a data carrier on which a computer program element is stored. The computer program element can comprise the executable instructions. Alternatively or in addition, the computer program product can be a permanent or a volatile data memory. In this case again, the computer program product comprises a computer program element that comprises instructions.

The sequence of the steps of the method 100 given here can, inasmuch as logically appropriate, be carried out simultaneously or in another sequence.

The invention is not restricted to one of the above-described forms of embodiment, but can be modified in a variety of ways. All of the features and advantages emerging from the description and the drawing, including constructive details, spatial arrangements and method steps, can be significant to the invention, both in themselves as well as in a wide variety of combinations.

1. Computer-implemented method for ascertaining a value of a geometric parameter of at least one part to be measured of an object from at least one two-dimensional image of a measurement volume, wherein the measurement volume includes the object and the part to be measured of the object has a position in the measurement volume, wherein the at least one two-dimensional image is assigned to a recording geometry, wherein the recording geometry describes a geometric relationship between a detector for ascertaining two-dimensional images and the object, wherein the method comprises:
ascertaining at least one two-dimensional image of the measurement volume;
identifying the at least one part to be measured of the object in the at least one two-dimensional image, and ascertaining a value of the geometric parameter of the at least one part to be measured that has been identified.

2. The method of claim 1, wherein identifying the at least one part to be measured of the object in the at least one two-dimensional image, and ascertaining a value of the geometric parameter of the at least one part to be measured that has been identified, further comprises:
providing at least one two-dimensional reference image that includes at least one known value of at least one geometric reference parameter; and
comparing the at least one two-dimensional reference image with the at least one two-dimensional image.

3. Method of claim 2, wherein the at least one two-dimensional reference image can represent a measurement volume that comprises a reference object with the same target geometry as the object, wherein the at least one two-dimensional reference image is, in particular, a simulated or real image of the reference object.

4. The method of claim 2, wherein identifying the at least one part to be measured of the object in the at least one two-dimensional image, and ascertaining a value of the geometric parameter of the at least one part to be measured that has been identified, further comprises:
ascertaining the position of the at least one identified part to be measured in the represented measurement volume by means of the at least one two-dimensional image;
ascertaining a further position in the two-dimensional reference image, wherein the further position is assigned to the at least one geometric reference parameter;
ascertaining a deviation between the ascertained position and the further position; and
ascertaining a value of the geometric parameter of the at least one part to be measured that has been identified by means of the ascertained deviation.

5. Method of claim 2, wherein an image correlation method is used in comparing the at least one two-dimensional reference image with the at least one two-dimensional image.

6. Method of claim 1, wherein in ascertaining at least one two-dimensional image of the measurement volume, at least two two-dimensional images of the measurement volume are ascertained representing the object from different directions, wherein, at least in identifying the at least one part to be measured of the object in the at least one two-dimensional image, and ascertaining a value of the geometric parameter of the at least one part to be measured that has been identified, all of the at least two two-dimensional images are used together.

7. Method of claim 1, wherein in ascertaining the at least one two-dimensional image of the measurement volume, the at least one part to be measured of the object is represented in strips, and/or the geometric parameter can extend parallel to the detector within a predefined tolerance angular range.

8. Method of claim 1, wherein in ascertaining at least one two-dimensional image of the measurement volume, at least two two-dimensional images of the measurement volume representing the object from different directions are ascertained, wherein the method, between that step and identifying the at least one part to be measured of the object in the at least one two-dimensional image, and ascertaining a value of the geometric parameter of the at least one part to be measured that has been identified, comprises:
ascertaining at least one region in the at least two two-dimensional images, in which no part of the object is arranged; and
ascertaining at least one envelope surface in the measurement volume that encloses the object, by means of the at least one region;
wherein, in identifying the at least one part to be measured of the object in the at least one two-dimensional image, and ascertaining a value of the geometric parameter of the at least one part to be measured that has been identified, the value is ascertained by means of the envelope surface.

9. Method of claim 1, wherein identifying the at least one part to be measured of the object in the at least one two-dimensional image, and ascertaining a value of the geometric parameter of the at least one part to be measured that has been identified, further comprises:
ascertaining the position of the at least one identified part to be measured in the measurement volume from a pre-known position and alignment of the object in the measurement volume, and a pre-known geometry that is assigned to the object.

10. Method of claim 1, wherein in ascertaining at least one two-dimensional image of the measurement volume, at least two two-dimensional images of the measurement volume are ascertained representing the object with different recording geometries, wherein identifying the at least one part to be measured of the object in the at least one two-dimensional image, and ascertaining a value of the geometric parameter of the at least one part to be measured that has been identified, further comprises:
ascertaining a two-dimensional position of the at least one identified part to be measured of the object in the at least two two-dimensional images; and
ascertaining the position of the identified at least one part to be measured in the measurement volume by means of the two-dimensional positions of the identified at least one part to be measured in the at least two two-dimensional images, and a change between the different recording geometries.

11. Method of claim 1, wherein the method, before ascertaining at least one two-dimensional image of the measurement volume, further comprises:
ascertaining an actual recording geometry of the at least one two-dimensional image;
ascertaining a target recording geometry for the at least one two-dimensional image;
ascertaining a deviation between the actual recording geometry and the target recording geometry; and
correcting the deviation in the actual recording geometry.

12. Method of claim 1, wherein at least one marker element is arranged at a predefined position in the measurement volume, wherein the recording geometry of the at least one two-dimensional image is ascertained by means of the at least one marker element.

13. Method of claim 1, wherein the method, before ascertaining at least one two-dimensional image of the measurement volume, further comprises:
deriving an optimum recording geometry for the at least one two-dimensional image from pre-known properties of the variable to be measured and a geometry of the object.

14. Method of claim 1, wherein in ascertaining at least one two-dimensional image of the measurement volume, the at least one two-dimensional image is ascertained by means of a radiographic measurement, and a further object touches the at least one part to be measured of the object, wherein, in identifying the at least one part to be measured of the object in the at least one two-dimensional image, and ascertaining a value of the geometric parameter of the at least one part to be measured that has been identified, a position of the further object is ascertained for determination of the position of the at least one identified part to be measured.

15. Computer program product with instructions that can be executed on a computer which, when executed on a computer, cause the computer to carry out the method of claim 1.
